(19) United States
(12) Patent Application Publication
(10) Pub. No.: US 2022/0246043 A1
(43) Pub. Date: Aug. 4, 2022

(54) AIRCRAFT STANDBY ZONE MANAGEMENT SYSTEM

(71) Applicant: Skyway Technologies Corp., San Rafael, CA (US)

(72) Inventors: Clifford FERNANDEZ, San Rafael, CA (US); Kurt GRUTZMACHER, San Rafael, CA (US); Derrick Harry LEWIS, San Rafael, CA (US)

(21) Appl. No.: 17/167,673

(22) Filed: Feb. 4, 2021

(51) Int. Cl. G08G 5/00; B64C 39/02

(52) U.S. Cl. CPC G08G 5/0043; B64C 39/024; G08G 5/0013; B64C 2201/143; B64C 2201/128; B64C 2201/122; B64C 2201/145; B64C 2201/027

(57) ABSTRACT

Systems and methods for managing drones using standby zones are described. An aircraft (e.g., drone or UAV) standby zone management system manages drones in three-dimensional zones, each zone having a specific elevation (or height), longitude, and latitude. For example, a number of drones can service or otherwise travel through a specific airspace or geographical location (e.g., an area surrounding a warehouse). Before executing flight plans, the drones remain in a standby mode, where they await instructions. The system manages these standby zones, moving the drones from zone to zone as they remain in their standby mode of operation.

### BACKGROUND

Drones and other UAVs (Unmanned Aerial Vehicles) have many different uses, including surveillance, package delivery, remote sensing, exploration and monitoring of locations, construction and surveying applications, and so on. While the control and management of individual drones can be managed, scenarios that utilize many different drones (from different entities) can introduce complexities and issues relating to the utilization, navigation, and/or management of drones (or groups or fleets of drones), among other drawbacks.

### BRIEF DESCRIPTION OF THE DRAWINGS

FIG. 1 is a diagram illustrating a zone management system for drones.

FIG. 2 is a flow diagram illustrating an example method for managing drones using zones.

FIG. 3 is a diagram illustrating example flows of information when managing drones using zones.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Systems and methods for managing drones using standby zones are described. An aircraft (e.g., drone or UAV) standby zone management system manages drones in three-dimensional zones, each zone having a specific elevation (or height), longitude, and latitude. For example, a number of drones can service or otherwise travel through a specific airspace or geographical location (e.g., an area surrounding a warehouse). Before executing flight plans, the drones remain in a standby mode, where they await instructions. The system manages these standby zones, moving the drones from zone to zone as they remain in their standby mode of operation.

In doing so, the system enables a group or fleet of drones to move into standby modes near a location without collisions or other issues between drones, among other benefits. By breaking up three-dimensional space into blocks (e.g., cubes or other shapes within space), the system can assign an individual drone to an individual block (or group of blocks), ensuring that a drone has sufficient space to fly in standby mode and avoid other drones.

In the following description, for the purposes of explanation, numerous specific details are set forth in order to provide a thorough understanding of implementations of the present technology. It will be apparent, however, to one skilled in the art that implementations of the present technology can be practiced without some of these specific details. The phrases “in some implementations,” “according to some implementations,” “in the implementations shown,” “in other implementations,” and the like generally mean the particular feature, structure, or characteristic following the phrase is included in at least one implementation of the present technology and can be included in more than one implementation. In addition, such phrases do not necessarily refer to the same implementations or different implementations.

### Examples of the Aircraft Standby Zone Management System

As described herein, the systems and methods provide a management system for drones, which enables an entity or organization to control and manage standby operations for drones within three-dimensional airspace. The drones described herein include drones configured to delivery items (e.g., package delivery drones), surveillance drones, transportation drones (e.g., drones capable of transporting a person from one location to another), and so on.

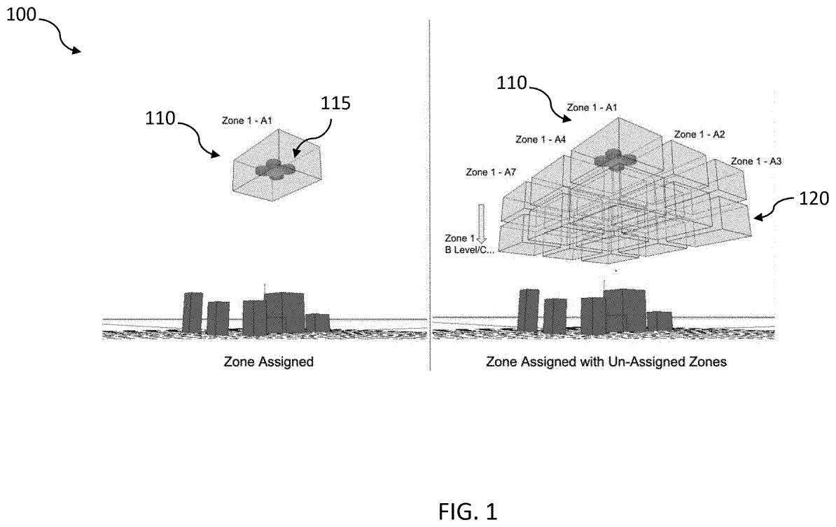

FIG. 1 is a diagram illustrating a zone management system 100 for drones. The zone management system 100 depicts a drone 115, or aircraft (e.g., UAV), located in a zone 110 above or within a certain geographical location. The zone 110 is occupied with the drone 115, and no other drones will be moved to that zone 110.

However, there are other unoccupied or available zones 120 that can receive or take in additional drones to be placed in standby modes. These zones, which are defined in three dimensions (latitude, longitude, elevation), can span across the space, as well as be located at different elevations.

For example, the zones, or blocks, can be arranged in layers or levels based on elevation. As depicted, a first layer of A blocks (A1, A2, A3, . . . ) sits above a second layer of B blocks. The system, therefore, can assign a certain block to a drone, causing the drone to navigate to the airspace represented by the block. As an example, drone 115 sits within a block Zone 1-A1.

FIG. 1 and the components depicted herein provide a general computing environment and network within which the system can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network can be any network, ranging from a wired or wireless local area network (LAN), to a wired or wireless wide area network (WAN), to the Internet or some other public or private network. While the connections between the system and other aspects are shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system may reside on a server computer, while corresponding portions may reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

As described herein, by breaking up three-dimensional space into blocks (e.g., cubes or zones within space), the system can assign an individual drone to an individual block (or group of blocks), ensuring that a drone has sufficient space to fly in standby mode and avoid other drones.

To do so, the system can include various functional modules configured to perform the operations described herein. For example, the system can include: a request module that receives a request from a drone to be placed in a standby mode of operation, a zone selection module that selects, within the certain area, a zone represented by a section of three-dimensional space that is unoccupied by other drones at the certain area, and/or a communication module that sends, to the unmanned aerial vehicle, an identifier for the selected zone.

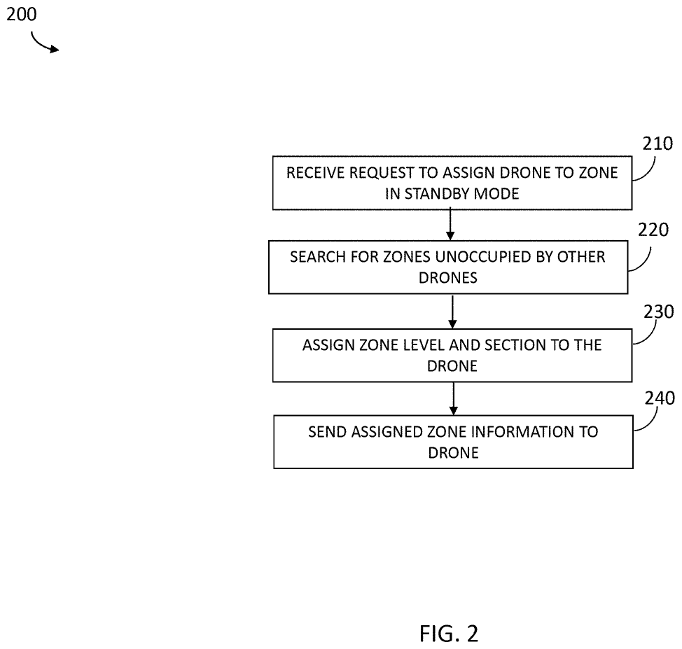

FIG. 2 is a flow diagram illustrating an example method 200 for managing drones using selected standby zones. Aspects of the method 200 may be performed by the drone system and, accordingly, is described herein merely by way of reference thereto. It will be appreciated that the method 200 may be performed on any suitable hardware.

In operation 210, the system receives a request to assign a drone to a zone area. For example, the system can receive the request directly from a drone and/or from a drone management system that controls drone operations. The request can include a zone area or location, such as an identifier for a zone associated with a certain location. The location can include a warehouse or other building, package delivery area, geographical location being surveilled or surveyed, and so on.

In operation 220, the system searches for zone levels currently unassigned or unoccupied by another drone. For example, the system can identify a level of unoccupied blocks, a section of a level of unoccupied blocks, and/or one or more unoccupied blocks.

The system, in some cases, may identify blocks as unoccupied or available based on the number of other surrounding or neighbor blocks also unassigned. For example, to enable a drone to navigate and travel to a certain standby zone represented by a block, the system can identify and/or utilize other blocks that are unoccupied, such that the drone does not collide into other drones within those blocks when traveling to its assigned standby zone. Thus, the system can search for levels, sections, or other groupings of zones or blocks.

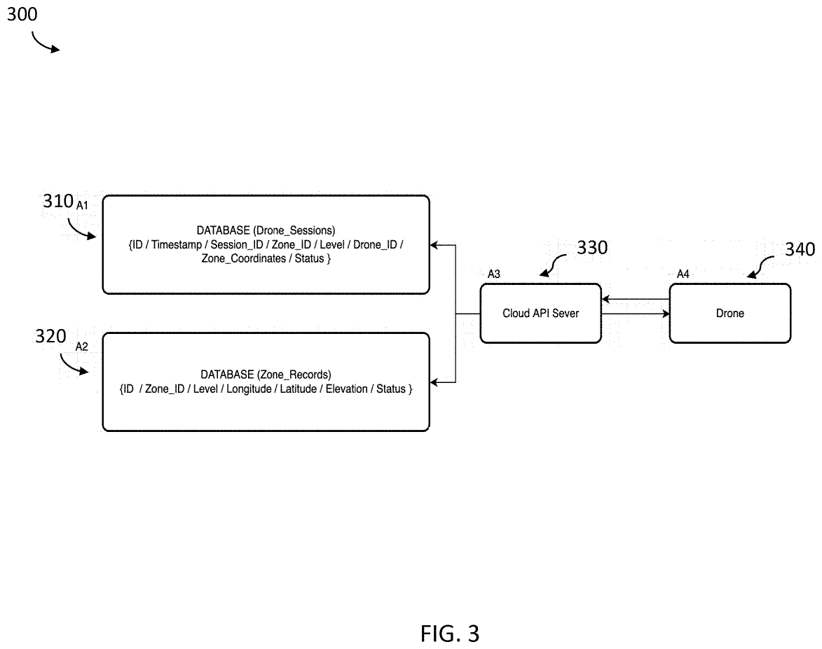

The system can search a database configured to store information identifying drones to assigned zones. FIG. 3 is a diagram illustrating example flows of information 300 when managing drones using zones. The system includes a drone sessions database 310 having a variable table list that manages sessions between drones and the system. The table list can include the following information:

ID, Row ID;

Timestamp, Time of Record;

Session ID, Random 16char VAR;

Zone_ID, Zone ID from Table “Zone_Records”;

Level, Level Letter & Number Assigned;

Drone_ID, Drone number Assigned;

Zone_Coordinates, JSON [Long, Lat, Elevation];

Status, Status of Standby; and so on.

Further, the system includes a zone database 320, which has a variable table list that records the approved zone areas and center point of coordinates for the zones (or blocks). The table list can include the following information:

ID, Row ID;

Zone_ID, A equine alphanumeric number;

Level, Level of Zone Letter with Number;

Longitude, Longitude;

Latitude, Latitude;

Elevation, Elevation;

Status, Status of Zone; and so on.

As depicted, a drone 340 calls an API 330 to access the databases 310, 320, in order to request a zone to travel to when being placed in standby mode.

Returning back to FIG. 2, in operation 230, the system assigns a zone level and section to the drone. For example, the system, in FIG. 1, assigned the drone 115 to zone 110, represented by its level (A) and its section (A1). For example, the system selects a zone represented by a section of three-dimensional space that is unoccupied by other unmanned aerial vehicles. The system can determine the zone is unoccupied by searching a database, such as database 320, that associated with the area that stores occupancy information for blocks of three-dimensional space for each zone of the area.

In operation 240, the system sends a standby command to a drone, which includes the assigned zone coordinates. Upon receiving the command or instruction, the drone can navigate and travel to the assigned zone and operate in a standby mode. Before or while sending the command, the system can update the database, which stores the information relating the drones to their assigned zones.

Thus, in some embodiments, the system manages the movement of drones within an area when they are in standby mode or otherwise awaiting instructions to travel to a different location. The system, as described herein, manages the drones or UAVs, by: receiving a request from the unmanned aerial vehicle to be placed in a standby mode of operation, identifying an area for the unmanned aerial vehicle to be placed in the standby mode of operation, selecting, within the identified area, a zone represented by a section of three-dimensional space that is unoccupied by other unmanned aerial vehicles at the area, and sending, to the unmanned aerial vehicle, coordinates for the selected zone (where the coordinates identify a latitude, longitude, and elevation for the selected zone).

As described herein, in some cases, the system may also identify a path of travel for the UAV, in order for the UAV to travel from a current location to a selected zone without traveling through other zones that may have (or be predicted to have) other UAVs contained in the zones. Thus, the system may determine a current location of the unmanned aerial vehicle with respect to the selected zone, identify a path of other zones within the unidentified area from the current location of the unmanned aerial vehicle to the selected zone, where the path of other zones includes drones that are currently unoccupied by other drones, and send instructions to the unmanned aerial vehicle to travel to the selected zone via the identified path of other zones. For example, the system can send to the UAV an identifier or coordinates for the selected zone (e.g., A3), as well as a path of zones to travel to the selected zone (e.g., A6 to A5 to A4 to A3).

In some cases, the system may attempt to space drones within the area such that the drones are not proximate to one another (e.g., are not in adjoining zones in any direction) and/or are on different levels or layers of zones within the area, when feasible. Thus, the system can select a zone based on a proximity of the selected zone to other zones within the identified area that are unoccupied by other unmanned aerial vehicles, and/or select a zone within a horizontal layer of zones that is unoccupied by other unmanned aerial vehicles.

Further, the system can select multiple zones for a UAV based on a variety of factors, including a known or provided size of the UAV, a speed or navigational capabilities of the UAV, and so on. Thus, in some cases, the system can select multiple zones based on an identified size of the unmanned aerial vehicle. In addition, in some embodiments, one or more zones can be allotted as an emergency descent area for distressed UAVs, such as zones that are clear from people or traffic below.

Thus, as described herein, the system can manage the movement of drones and other aircraft using zones or blocks that represent zones of three-dimensional space at an area. The system can be implemented by a single entity (such as a package delivery company), at a certain location or area, and/or by a drone navigation entity, such as an entity that manages the movement of drones along a navigational highway in the airspace (where standby areas are located at or along certain areas of the drone highway).

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order; and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

We claim:

1. A method for managing an unmanned aerial vehicle in a standby mode, the method comprising:
receiving a request from the unmanned aerial vehicle to be placed in a standby mode of operation;
identifying an area for the unmanned aerial vehicle to be placed in the standby mode of operation;
selecting, within the identified area, a zone represented by a section of three-dimensional space that is unoccupied by other unmanned aerial vehicles at the area; and
sending, to the unmanned aerial vehicle, coordinates for the selected zone,
wherein the coordinates identify a latitude, longitude, and elevation for the selected zone.

2. The method of claim 1, wherein selecting a zone represented a section of three-dimensional space that is unoccupied by other unmanned aerial vehicles includes:
determining a current location of the unmanned aerial vehicle with respect to the selected zone; and
identifying a path of other zones within the unidentified area from the current location of the unmanned aerial vehicle to the selected zone,
wherein the path of other zones includes drones that are currently unoccupied by other drones; and
wherein sending, to the unmanned aerial vehicle, coordinates for the selected zone includes sending instructions to the unmanned aerial vehicle to travel to the selected zone via the identified path of other zones

3. The method of claim 1, wherein selecting a zone represented a section of three-dimensional space that is unoccupied by other unmanned aerial vehicles includes searching a database associated with the area that stores occupancy information for blocks of three-dimensional space for each zone of the area.

4. The method of claim 1, wherein the request from the unmanned aerial vehicle includes information identifying a size of the unmanned aerial vehicle; and wherein selecting a zone represented by a section of three-dimensional space that is unoccupied by other unmanned aerial vehicles at the area includes selecting multiple zones based on the identified size of the unmanned aerial vehicle.

5. The method of claim 1, wherein selecting a zone represented by a section of three-dimensional space that is unoccupied by other unmanned aerial vehicles at the area further includes selecting a zone based on a proximity of the selected zone to other zones within the identified area that are unoccupied by other unmanned aerial vehicles.

6. The method of claim 1, wherein selecting a zone represented by a section of three-dimensional space that is unoccupied by other unmanned aerial vehicles at the area further includes selecting a zone within a horizontal layer of zones that is unoccupied by other unmanned aerial vehicles.

7. The method of claim 1, wherein the identified area is associated with a product storage warehouse.

8. The method of claim 1, wherein the identified area is associated with a package delivery geographical location.

9. The method of claim 1, wherein the identified area is associated with a geographical location being monitored by unmanned aerial vehicles.

10. The method of claim 1, wherein the identified area is associated with an unmanned aerial vehicle navigational highway.

11. A non-transitory, computer-readable medium whose contents, when performed by a computing device, cause the computing device to perform a method for managing an unmanned aerial vehicle in a standby mode, the method comprising:
receiving a request from the unmanned aerial vehicle to be placed in a standby mode of operation;
identifying an area for the unmanned aerial vehicle to be placed in the standby mode of operation;
selecting, within the identified area, a zone represented by a section of three-dimensional space that is unoccupied by other unmanned aerial vehicles at the area; and
sending, to the unmanned aerial vehicle, coordinates for the selected zone,
wherein the coordinates identify a latitude, longitude, and elevation for the selected zone.

12. The computer-readable medium of claim 11, wherein selecting a zone represented a section of three-dimensional space that is unoccupied by other unmanned aerial vehicles includes:
determining a current location of the unmanned aerial vehicle with respect to the selected zone; and
identifying a path of other zones within the unidentified area from the current location of the unmanned aerial vehicle to the selected zone,
wherein the path of other zones includes drones that are currently unoccupied by other drones; and
wherein sending, to the unmanned aerial vehicle, coordinates for the selected zone includes sending instructions to the unmanned aerial vehicle to travel to the selected zone via the identified path of other zones.

13. The computer-readable medium of claim 11, wherein selecting a zone represented a section of three-dimensional space that is unoccupied by other unmanned aerial vehicles includes searching a database associated with the area that stores occupancy information for blocks of three-dimensional space for each zone of the area.

14. The computer-readable medium of claim 11, wherein the request from the unmanned aerial vehicle includes information identifying a size of the unmanned aerial vehicle; and wherein selecting a zone represented by a section of three-dimensional space that is unoccupied by other unmanned aerial vehicles at the area includes selecting multiple zones based on the identified size of the unmanned aerial vehicle.

15. The computer-readable medium of claim 11, wherein selecting a zone represented by a section of three-dimensional space that is unoccupied by other unmanned aerial vehicles at the area further includes selecting a zone based on a proximity of the selected zone to other zones within the identified area that are unoccupied by other unmanned aerial vehicles.

16. The computer-readable medium of claim 11, wherein selecting a zone represented by a section of three-dimensional space that is unoccupied by other unmanned aerial vehicles at the area further includes selecting a zone within a horizontal layer of zones that is unoccupied by other unmanned aerial vehicles.

17. A system for managing drones located within a certain area, the system comprising:
a request module that receives a request from a drone to be placed in a standby mode of operation; and
a zone selection module that selects, within the certain area, a zone represented by a section of three-dimensional space that is unoccupied by other drones at the certain area; and
a communication module that sends, to the unmanned aerial vehicle, an identifier for the selected zone.

18. The system of claim 17, wherein the identifier for the selected zone includes coordinates that identify a latitude, longitude, and elevation for the selected zone.

19. The system of claim 17, wherein the identifier for the selected zone includes coordinates that identify a latitude, longitude, and elevation for a horizontal layer of zones within the certain area.

20. The system of claim 17, wherein the certain area is part of a drone navigational highway.
